(19) United States
(12) Patent Application Publication
(10) Pub. No.: US 2020/0037400 A1
(43) Pub. Date: Jan. 30, 2020

(54) ELECTRIC FLUID HEATING SYSTEM AND METHOD OF USE THEREOF

(71) Applicant: LOGICOR (R&D) LTD, Wakefield (GB)

(72) Inventor: David Bowen, Wakefield (GB)

(21) Appl. No.: 16/495,902

(22) PCT Filed: Mar. 2, 2018
(86) PCT No.: PCT/GB2018/050541

§ 371 Date: Sep. 20, 2019

(30) Foreign Application Priority Data
Mar. 22, 2017 (GB) 1704497.5

(51) Int. Cl. H05B 3/00; F24H 1/10; F24H 9/18; F24H 9/20

(52) U.S. Cl. CPC H05B 3/0009; F24H 1/102; H05B 2203/021; F24H 9/2028; F24H 9/1818

(57) ABSTRACT

An electric fluid heating system is provided. The system includes first and at least second electrically powered heating elements. A fluid path is associated with each of the first and at least second heating elements and arranged such that heat can be transferred from the heating element to fluid containable within the associated fluid path when said heating element is in an operable condition in use. The first and at least second heating elements are independently operable and/or controllable.

This invention relates to an electric fluid heating system and to a method of use thereof.

Although the following description refers almost exclusively to an electric fluid heating system in the form of an electric boiler for heating a domestic or commercial water supply or source in a building, it will be appreciated by persons skilled in the art that the present invention could be used for heating swimming pool water, for heating any water, fluid or liquid supply, for use in under-floor heating, to power fluid containing radiators and/or the like.

Water heaters or boilers can come in a number of different forms, such as for example, storage or tank type water heaters, or continuous flow or tankless water heaters.

Storage or tank type water heaters typically consist of an insulated vessel, cylinder or container that keeps water continuously hot and ready to use. Typical cylinder sizes for household use range from 75 to 400 litres. They can use a variety of different energy sources to heat the same, such as electricity, gas, heating oil, solar energy and/or the like. Storage water heaters have the advantage that they use energy at a relatively slow rate compared to tankless heaters, storing the heat for later use. Disadvantages of this type of water heater is that the water inside the tank cools down over time causing the heating system to continually require reactivation to heat the water back up. In addition, once the tank's supply of hot water has been exhausted, there is a significant delay before hot water is available again. The pool of hot water can act as an incubator of bacterial colonies, such as Legionella bacteria.

Continuous flow or tank less type water heaters use high power heat exchangers to instantly heat water as it flows past the heat exchangers. Such heaters do not retain any water internally except for what is in the heat exchanger coil contained within the heater. An advantage of these devices is that there is a plentiful and continuous supply of hot water. A disadvantage of these devices is that they require high power heaters to provide sufficient transfer of heat to the water as it flows past the heat exchanger coil. In addition, the heat exchangers are either in “on” or “off” conditions.

In both of the abovementioned systems, a user typically obtains warm or hot water at a desired temperature by mixing warm or hot water from the tank or heater with cold water from a cold water supply using a tap outlet.

It is an aim of the present invention to provide an improved electric fluid heating system.

It is a further aim of the present invention to provide an improved method of using an electric fluid heating system.

According to a first aspect of the present invention there is provided an electric fluid heating system, said system including first and at least second electrically powered heating elements, a fluid path associated with each of the first and at least second heating elements and arranged such that heat can be transferred from the heating element to fluid containable within the associated fluid path when said heating element is in an at least an operable condition in use, and wherein the first and at least second heating elements are independently operable and/or controllable.

Thus, by providing an electrically powered fluid heating system that has a plurality of electrically powered heating elements which can be controlled and/or operated independently of each other, this provides the system with a greater degree of control compared to prior art electric fluid heating systems. This greater degree of control allows heated fluid to be delivered to a required location at a faster rate, reduces the amount of electrical energy required to operate the system, increases the efficiency and reduces the cost of operating the system and/or the like.

Preferably the electric fluid heating system is a tankless or continuous flow type of heating system.

In one embodiment the first and at least second heating elements and the associated fluid paths are provided in a unit housing, and further preferably a single unit or unit housing.

In one embodiment six heating elements are provided in the system. However, more or less heating elements could be provided depending on the size of the required system, boiler and/or the volume of fluid to be heated by the same in use.

Preferably at least six fluid flow paths are provided in the system.

In one embodiment the number of fluid flow paths in the system equals the number of heating elements in the system.

In one embodiment there are more heating elements than fluid flow paths in the system.

Preferably the fluid flowable through each fluid path is independently controllable.

Preferably each fluid path is provided adjacent to, is in direct or substantially direct contact with and/or in abutting relationship with the associated heating element(s). As the fluid flows along the fluid path in use, heat is transferred from the associated heating element, at least when the heating element is in an “on” condition, to the fluid. The heated fluid is then transported along the fluid path to exit the fluid path at a required outlet or outlet means. It will be appreciated that heat may still be transferred to the surrounding fluid in the associated fluid path even when the heating element is in an “off” condition due to the heating element retaining heat for a pre-determined time period after it is switched from an “on” condition to an “off” condition.

Preferably a, or each, fluid path is provided around, adjacent and/or abutting each heating element.

In one embodiment one or more walls defining the fluid path are a spaced distance apart from its associated heating element and the fluid flowing through the fluid path (i.e. between the wall and the heating element) in use is typically contactable with an exterior surface of the associated heating element directly in one example. Thus, the fluid path is acting as a guide to guide the fluid with respect to its associated heating element in such a way that heat is transferable from the heating element to the fluid locatable in the fluid path.

Preferably the fluid paths are integrally formed or defined in at least one block or body of material of the system and the heating elements are located in said block or body of material in relation to their associated fluid path(s).

Preferably the fluid path is a channel defined in a unit body of material around at least part of a, or each, heating element.

Preferably the walls defining the channel of the fluid path are typically a spaced distance apart from the heating element.

Preferably each fluid path and/or heating element is independently in communication with control means or apparatus.

Preferably each, or one or more, fluid paths has valve means or apparatus associated with the same to allow the flow and/or volume of fluid contained and/or flowing through the same to be independently controllable.

Preferably the valve means or apparatus are controlled automatically via the control means or apparatus, and/or could be in the form of a motorised valve and/or the like.

Preferably each individual fluid path has an inlet or inlet means for allowing fluid to flow into the same and an outlet or outlet means for allowing fluid to exit the same in use.

Preferably each or one or more of the individual fluid paths has inlet valve means or apparatus for controlling the rate and/or volume of fluid flowing into the individual fluid path(s), and outlet valve means or apparatus for controlling the rate and/or volume of fluid out of the individual fluid path(s).

In one embodiment each fluid path follows a curved, substantially curved, spiral, substantially spiral, helix and/or substantially helix path around the heating element with which it is associated. This allows the fluid within the fluid path to be kept in contact with its associated heating element(s) for a longer period of time in operation and allows a greater volume of water to be in contact with the heating element at any one time compared to if the fluid path were arranged in a linear path. For example, a spiral fluid flow path increases the time the fluid is in contact with the heating element by more than 300% compared to a linear fluid flow path.

Preferably each fluid path repeatedly winds around an axis of the heating element, and further preferably between two ends of the heating element.

Preferably each fluid path repeatedly winds around a longitudinal axis of the heating element.

Preferably the spiral path is a three dimensional curve that turns around an axis at a constant or substantially constant, varying or substantially varying distances while remaining parallel or substantially parallel to the axis.

Preferably the electric fluid heating system or a housing of the system has a main fluid inlet means or mechanism for allowing fluid to enter the system or housing and a main fluid outlet means or mechanism for allowing fluid to exit the system or housing.

In one embodiment fluid conduit means are provided between the main fluid inlet means or mechanism and the main fluid outlet means or mechanism. Preferably the individual fluid paths associated with each, or two or more, of the heating elements communicate with the conduit means via their own fluid path inlet means or mechanism and fluid path outlet means or mechanism.

In one embodiment each or one or more individual fluid paths is capable of communication or are arranged so that it can communicate selectively with an adjacent fluid path.

Preferably the communication between fluid flow paths depends on whether valve means or mechanism between the fluid paths are open or closed. When the valve means or mechanism are open, fluid can flow in one fluid path to an adjacent fluid path. When the valve means or mechanism are closed, fluid is prevented from flowing from one fluid path to an adjacent fluid path. Any or any combination of fluid path valves or valve means/mechanism could be independently opened and/or closed so that there are different combinations of fluid paths in which fluid is capable of flowing through the system in use.

For example, the system (or the valve means of the system) could be arranged such that a particular volume of fluid could flow past all the heating elements in succession. Alternatively, the system or valve means of the system could be arranged such that a particular volume of fluid could flow in the first and third fluid flow paths in succession but bypass the second and fourth fluid flow paths, for example.

Preferably two or more fluid flow paths are arranged a spaced distance apart within the unit/housing of the system.

Preferably each, or one or more, fluid flow paths, the valve means or mechanism associated with each or said fluid flow paths and/or the heating elements are uniquely identified by identification means or code so that the control means can identify, operate and/or communicate with each, or groups of them, independently of the others.

In one embodiment only part of the fluid flow path is arranged as a spiral, curve or helix (or substantial spiral, curve or helix) around the heating element. A remaining part of the fluid flow path can take a different form, such as for example a linear or substantially linear form.

Preferably power output levels to the at least first and second heating elements are independently operable and/or controllable.

Preferably each heating element includes at least one elongate arm member, and preferably at least one elongate linear or substantially linear arm member.

Preferably each heating element is U-shaped or substantially U-shaped. For example, each heating element can include two parallel or substantially parallel elongate heating element portions with a transverse or curved heating element portion located between the two parallel heating element portions, at least at one end of the arrangement.

Preferably each or two or more heating elements within the system is/are arranged to be heated and/or powered in sequence. Thus, preferably each or two or more heating elements is/are typically arranged to be moved between “on” and “off” conditions in turn. Preferably this is the case when the system as a whole is in an operable or “on” condition. Preferably each heating element is arranged to be heated or powered in a repetitive sequence such that each heating element is only powered for a relatively short period of time, such as for example 0.1 second, 1 second, 10 seconds and/or the like.

Preferably the number of the heating elements controlled to be in an “on” or a relatively “high” power condition or an “off” or relatively “low” power condition is dependent on the volume and/or temperature of the fluid that is required to be heated at any particular time or for any particular time period.

Preferably one or more of the heating elements are arranged or controlled to be in an “on” condition or a relatively “high” power consuming position when one or more of the other heating elements are arranged or controlled to be in an “off” condition or a relatively “low” power consuming position.

Preferably the system and/or control means is arranged to operate different heating elements during different heating operations of the system, thereby increasing the life expectancy of the system. For example, if a first and third heating element is used to heat fluid in one heating operation, a second and fourth heating element can be used to heat fluid in the next adjacent operation in time.

For example, the same heating elements may not be used for consecutive heating operations performed by the system.

Preferably the heating elements are arranged to pulse between “on” and “off” or relatively “high” or “low” power consumption conditions in rapid succession so as to reduce the overall power consumed by the system. Preferably the time period the heating elements are in the “off” or “low” power consuming condition is sufficiently short that no substantial loss of heat results in the heating elements. Thus, the fluid surrounding a heating element could be continually or substantially continually heated, even though the heating element associated with the fluid is being moved between “on” and “off” conditions or “high” or “low” conditions.

Preferably the electric fluid heating system is in the form of a boiler or heater, and preferably a tank-less boiler/heater or continuous flow boiler/heater.

Preferably the fluid flowing through the electric fluid heating system is or includes water, such as for example a mains water supply.

Preferably electricity is supplied to the system via at least one electrical cable or cable means.

Preferably the electricity used to power the system is provided by a mains electrical supply.

Preferably the housing and/or unit includes ventilation and/or cooling means or apparatus provided on or associated therewith to prevent the housing and/or unit from becoming too hot in use. In one embodiment the ventilation and/or cooling means or apparatus could include any or any combination of one or more apertures, slots, heat sinks, heat fins, fan and/or the like.

In one embodiment control means or apparatus are provided for controlling the heating system, the heating elements, the valve means or apparatus, the fluid paths and/or the like. The control means can control one or more parameters, functions and/or characteristics of the heating system, the heating elements, the valve means, the fluid paths and/or the like.

In one embodiment the control means includes or is associated with switching means for controlling and/or switching the supply of electricity to one or more or all of said heating elements in use. The switching means can be controlled by the control means according to one or more parameters, functions and/or characteristics, such as for example user selected parameters, service provider selected parameters and/or one or more pre-determined parameters.

Preferably relay means or one or more relays are used in the electronic circuitry, control means and/or switching means of the system to allow pulsing or switching of the heating elements between the “on” and “off” conditions in use.

Preferably the heating element are arranged to be sequenced, pulsed and/or switched between the on and off or between the relatively high and low power consuming positions in succession or rapid succession according to a pre-determined mathematical algorithm. The algorithm is typically performed using software provided in or associated with control means for the system.

Preferably the switching means can be switched according to one or more pre-determined time periods and/or time parameters. The time period could be fractions of a second, seconds, minutes, hours, days, weeks, months, years and/or the like.

Preferably switch means or a switch is associated with each heating element within the system. For example, a single switch could be used to control two or more electric heating elements or a single switch could be used to control each heating element independently of any other heating element within the system.

In one embodiment the control means are arranged to actuate the switch means of two or more of the plurality of electric heating elements successively (i.e. one after another and/or in a particular sequence). Alternatively the control means are arranged to actuate the switch means to two or more or all of the electrical heating elements simultaneously or substantially simultaneously.

Preferably the control means controls actuation of the switching means of the heating elements between “on” and “off” conditions and/or between “high” and “low” power consuming conditions. The heating elements are typically capable of being heated when in an “on” condition and cannot be heated when in an “off” condition (although could still be capable of heating the fluid in the associated fluid path due to existing heat present in the heating element).

In one embodiment in order to allow one or more or all of the heating elements to operate within, above or below one or more selected or predetermined parameters, functions and/or characteristics, at least one heating element within the system is not switched on and/or operable all of the time or is provided with a reduced electric power supply for part of a total time period relative to a remaining time period for which the system is operational. Thus, the heating elements can successively supply or receive electrical energy in turn for short pre-determined periods of time. One or more of the heating elements in the system may be switched to an “off” or relatively low power consuming position when one or more other heating elements in the system are switched to an “on” or relatively high power consuming position in one example.

In one example, a user could set the control means of the fluid heating system so that a selected wattage is used by one or more of the heating elements over a selected time period in order to achieve a certain temperature or temperature range of said system.

In one embodiment a value range and/or an upper and/or lower threshold limit for a particular parameter, function and/or characteristic being controlled and/or data item being communicated is pre-determined and/or can be selected by a user.

Preferably the one or more parameters, functions and/or characteristics include the amount of energy consumable by said one or more electric heating elements and/or system as a whole.

The control means is typically arranged to allow control of any or any combination of the following one or more parameters, functions and/or characteristics, such as for example volume of fluid being heated at any particular time, the temperature of the fluid being heated, the time of day at which the fluid is heated, a plurality of times of day at which the fluid is to be heated, the length of time for which the fluid is heated for, which heating elements are being used to supply the heat to heat the fluid at any particular time, which fluid paths are to be used to allow flow of fluid through the system at any particular time, the wattage of electrical power used by the system and/or one or more of the heating elements, the monetary value of the electrical energy being consumed, the amount of carbon being used, the carbon footprint (i.e. tonnes of carbon used) and/or the like.

In one example, the control means can be used to control the monetary value associated with one or more heating elements of the system, such as for example, the volume of fluid used in the system, the amount of electricity, the amount of carbon consumed, the desired temperature (for example the user could select a water temperature of 39.1° C. or 43.7° C.) and/or the like. This allows a user to set the heating system according to what they can afford to pay and/or what they want to pay in any particular time period. Once the wattage of electricity corresponding to a selected amount of money is spent or used, the switching means could move the heating elements from the “on” condition to the “off” condition.

In one embodiment the control means are provided in or associated with a water or fluid proof or water or fluid tight compartment or substantially water or fluid proof or water or fluid tight compartment within the unit and/or housing.

The control means or apparatus can be located within the system unit or housing or can be a stand alone, remote and/or independent control means or apparatus.

It is to be noted that the same control means can be used to control one or more other electrical and/or electronic devices separate to and/or independent to the fluid heating system if required. For example, the control means of the present invention could also be used to control an electric radiator or central heating system of a type described in the applicant's co-pending patent application WO2015/025122, which is incorporated herein by reference.

Preferably the system and/or control means or apparatus includes an electronic processing unit for processing one or more control signals and/or data associated with the system.

Preferably the control means or apparatus allows a user selected and/or pre-determined temperature to be set, such that fluid exits the system at the user selected and/or pre-determined temperature.

Preferably the preciseness of the control means could be to 0.1° C. (increments) if required.

A single control means can be provided or associated with each heating element or a single control means can be provided for controlling two or more or all the heating elements within the system.

In one embodiment a single control means controls all the heating elements within the system simultaneously or substantially simultaneously.

Preferably each heating element is arranged a spaced distance apart within the unit or housing of the system.

In one embodiment each heating element is arranged in a substantially parallel arrangement to an adjacent heating element. However, a person skilled in the art will appreciate that the heating elements can be provided in any suitable arrangement as required.

Preferably the user selected fluid temperature for the system is an arbitrary selected temperature.

Preferably the user selected and/or pre-determined fluid temperature selected for the system is one of a plurality of possible pre-determined temperatures that could be selected.

Preferably a single control means is provided for all the heating elements and/or fluid flow paths within the system. Alternatively, individual control means can be provided for each heating element and/or fluid flow path within the system.

Preferably the system includes communication means or apparatus for allowing the system to communicate with one or more external communication systems, a computer system, a server, the Internet, remote electronic processing means or apparatus, and/or the like.

Preferably the communication means or apparatus allows one or more signals and/or data to be sent and/or received by the control means, switching means and/or relays of the system.

In one embodiment the communication means or apparatus allows the electric fluid heating system of the present invention to communicate with an electric radiator or central heating system as described in the applicant's co-pending patent application WO2015/025122. In one example, this has the advantage that the pulsed electrical energy being used by both systems could be synchronised or substantially synchronised, but off set. This would allow electrical energy to be pulsed to one system when the other system does not require any, such that a constant or substantially constant amount of electrical energy is being used for both systems.

The communication means can include wired or wireless means. Signals and/or data can be communicated to and/or from the system via wireless (WiFi) signals, radio frequency (RF) signals infrared signals, light signals and/or the like.

In one embodiment the communication means includes one or more transmitters and/or receivers for transmitting and/or receiving one or more signals and/or data relating to the system.

In one example the electrical fluid heating system communicates with one or more other systems via an electric ring main in a building in which the system is located in use.

In one embodiment the communication means is arranged to allow the system of the present invention to be operated remotely.

Preferably the system is provided with Bluetooth means for allowing wireless communication. Other wireless communication means could include any or any combination of one or more radio designs, infra-red signals and/or the like.

In one embodiment the communication undertaken by the communication means is one way or uni-directional communication.

In one embodiment the communication undertaken by the communication means is two-way communication or bi-directional. This allows the system to receive data from a remote system, to allow software updates, electricity and/or fluid pricing updates and/or the like. Thus, in one example, the system is capable of transmitting data to one or more remote or other systems and the system is capable of receiving data from one or more remote or other systems.

In one embodiment the control means communicates with an external system. For example, the control means could receive data from an external system relating to weather conditions so that the system can determine or plan the temperature or temperatures it needs to set for fluid heating. In addition, or alternatively, the external system could provide electricity supplier data, emergency service provider data, historical data from other independent fluid heating systems and/or the like.

In one embodiment memory and/or data storage means or apparatus are provided on or associated with the system and/or control means to store data relating to the system. This data can be used to optimise operation of the system. For example, previously stored data can be used to determine the likely volume of fluid that needs to be heated on a particular day and/or time of day. The data stored could indicate the time of day when hot showers are normally taken on a week day compared to a weekend, whether more warm showers are taken in the winter compared to in the summer and/or the like. The stored data can feed back into the system to determine operation of the system.

Preferably the memory or data storage includes a secure digital (SD) card or other such memory card.

Preferably a user interface is provided with or associated with the system or the control means of the system. The user interface allows a user to select and/or control one or more parameters, functions and/or characteristics of the system.

The control means could be controlled via voice recognition, gesture control and/or the like.

Preferably the system and/or control means includes a visual display and/or touch screen display to allow the display and/or selection of the one or more parameters.

Preferably the control means includes one or more user actuation means or devices, control buttons, levers, dials and/or the like for allowing a user to set parameters, characteristics and/or functions associated with the system.

Preferably the control means allows a user to measure and/or monitor the electrical consumption of one or more of the electric heating elements, such as for example a particular time or time period, in addition to selecting the value or upper and/or lower limits of the electrical consumption of the heating element.

Preferably the unit or housing of the system has one or more panels that are attached or detachably attached to the same via attachment means. This allows removal of one or more panels in one embodiment to allow access to the system interior for repair, maintenance, replacement and/or the like.

The attachment means can include any or any combination of one or more screws, nuts and bolts, clips, friction fit, inter-engaging members, adhesive, solder, ties, magnets and/or the like.

Preferably the front panel of the housing or unit is detachably attached to one or more remaining walls of the housing or unit.

Preferably two or more walls of the housing are integrally formed.

Preferably engagement means are provided on or associated with the housing and/or unit to allow the same to be engaged to or with a wall or surface in use. The engagement means could include any or any combination of one or more screws, nuts and bolts, clips, hooks, inter-engaging members, ties, magnets and/or the like.

Preferably sensing means or one or more sensors are provided on or associated with the system for sensing one or more conditions of the system, for sensing one or more components of the system and/or one or more conditions in the surrounding area or locality in which the system is located.

In one embodiment temperature sensing means are provided on or associated with the system.

Preferably the temperature sensing means can be provided on or associated with the fluid inlet means and/or the fluid outlet means for measuring or monitoring the temperature of the inlet and/or outlet fluid flowing through the system in use. In one example the temperature sensing means is in the form of a thermistor.

In one embodiment heat sink means are provided on or associated with the system. In one example the heat sink means are provided on or associated with the fluid inlet means. The heat sink means acts to dissipate heat associated with electronic circuitry provided in the system, such as for example to dissipate heat associated with the switching means or relay means that control the pulsing or sequencing of the heating elements between on and off conditions in use.

In one embodiment fluid flow sensing and/or measuring means are provided on or associated with the system. In one example flow sensing means can be provided on or associated with the fluid inlet means for measuring the flow of fluid into the system in use.

Preferably the flow sensing means is in the form of a flow meter.

In one embodiment anti-scald means are provided on or associated with the system for preventing or reducing the likelihood of a user scalding themselves.

Preferably the anti-scald means is provided on or associated with the main fluid outlet means. In one example the anti-scald means is in the form of an anti-scald valve.

In one embodiment fire sensing means are provided on or associated with the system for sensing if a fire is located near the system.

Preferably the one or more sensing means could include temperature detection means in the locality of the system, smoke detection means and/or the like. This data can be used to communicate with a user of the system to inform them of a fire, fire danger and/or the like.

In one embodiment fluid leak sensing means are provided to detect a leak in or associated with the system.

Preferably the electric fluid heating system is an in-line electric heating system. This means that the fluid heating system is directly inserted or “in-line” with a cold water feed.

Preferably the system is arranged such that water or fluid only flows through the system when a fluid tap or fluid outlet associated or joined with the system is moved to an “on” condition from an “off” condition. For example, water can flow through the system when a hot water tap located in a bathroom remote from the heating system is turned on.

In one embodiment each fluid outlet within a locality is provided with control means that can communicate with the control means of the electric water system. For example, each hot tap within a building can be provided with its own control means such that a user can control the temperature of fluid being dispensed from each hot tap. This is of particular advantage if an adult wanted to limit the amount of hot water or the temperature of hot water being dispensed in a child's shower room or bathroom.

For example, the system could include one or more user selectively controllable fluid outlets or taps remote from a housing of the system to which fluid heated by the system is able to flow to in use, and each or one or more of said fluid outlets or taps has control means provided on or associated therewith and which are arranged to communicate with the control means provided in or associated with the system housing.

According to a second aspect of the present invention there is provided a method of using an electric fluid heating system.

According to one aspect of the present invention there is provided a method of using an electric fluid heating system, said system including first and at least second electrically powered heating elements, a fluid path associated with each of the first and at least second heating elements, said method including the steps of moving at least one of the heating elements to an operable condition, heating fluid contained in a fluid path surrounding said heating element, and independently controlling and/or operating the first and at least second heating elements.

The electric fluid heating system of the present invention can be used to replace a conventional boiler and hot water cylinder system. It can provide hot water or heated fluid on demand. It only heats the water or fluid when needed and in a volume that is needed, thereby reducing the amount of energy needed to heat the system and saving costs. The system includes no or a reduced number of moving parts compared to conventional fluid heating systems, thereby increasing the life expectancy of the system. The system does not require a pump to move fluid through the system as in the case of many conventional fluid heating systems. The system is unaffected by fluctuating water or fluid pressure, such that a user can turn a tap on and/or flush a toilet in the same building and this does not affect the temperature and/or flow of hot water or fluid produced by the system. The system of the present invention does not require fluid exiting from the system to be mixed with cold water since the system heats the temperature to the desired level. A further advantage of the present invention is that the resulting system is more compact than conventional boiler designs due to the system not storing any of the fluid and has therefore increased aesthetic appeal. Since water or fluid is not stored in the system, this also reduces the likelihood of bacterial contamination of the water.

An embodiment of the present invention will now be described with reference to the accompanying figures, wherein:

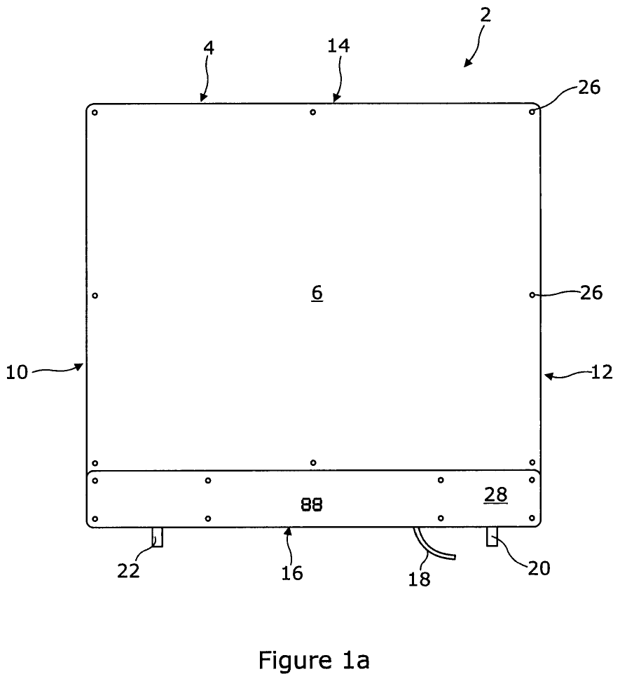

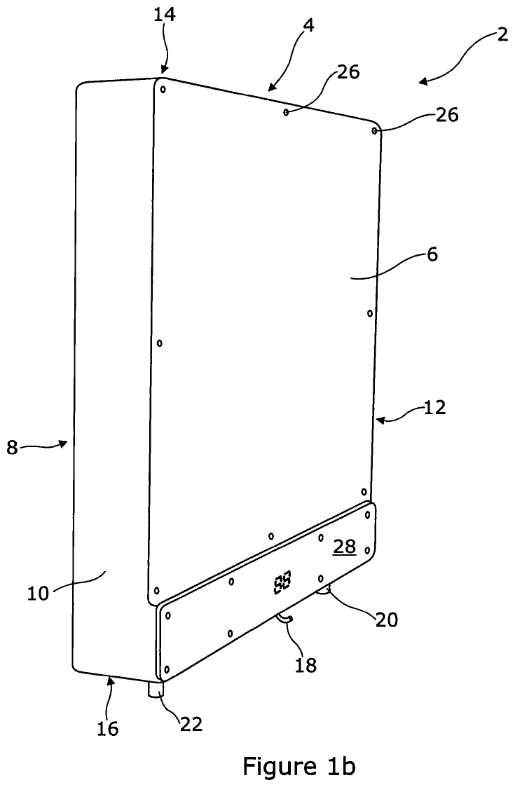

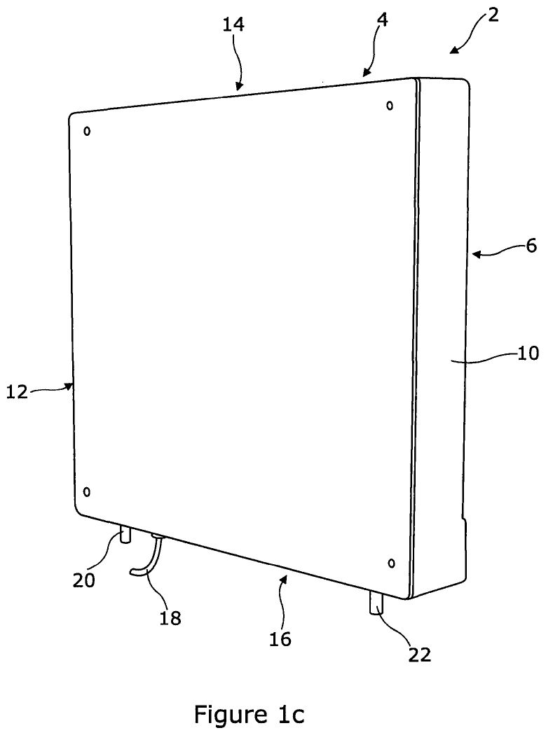

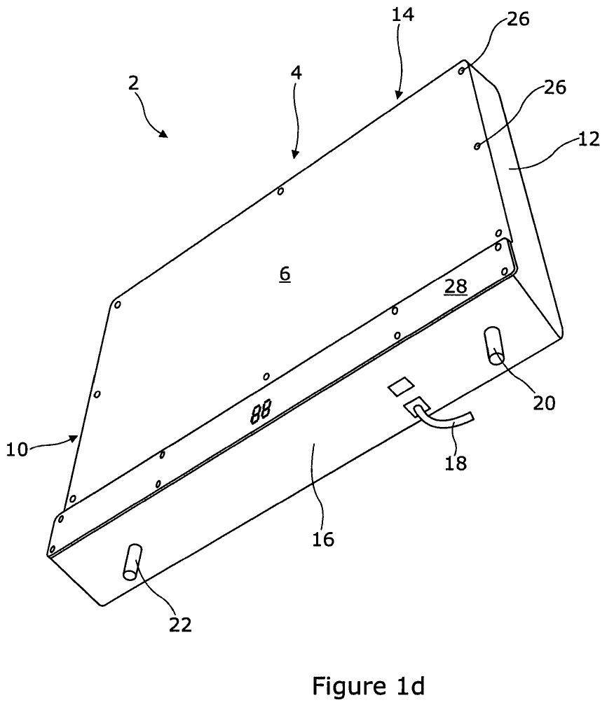

FIGS. 1a-1d show a front view, front perspective view, rear perspective view and base view respectively of an electric water heater according to an embodiment of the present invention;

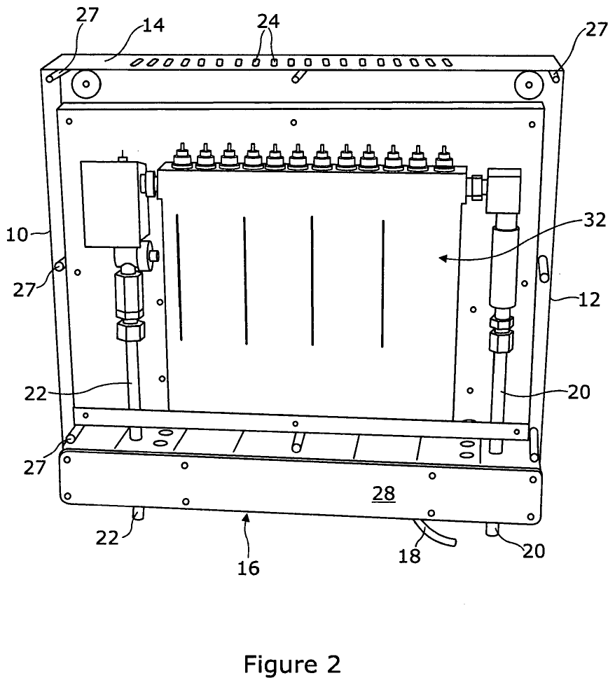

FIG. 2 is a front view of the electric water heater in FIGS. 1a-1d with the front cover removed;

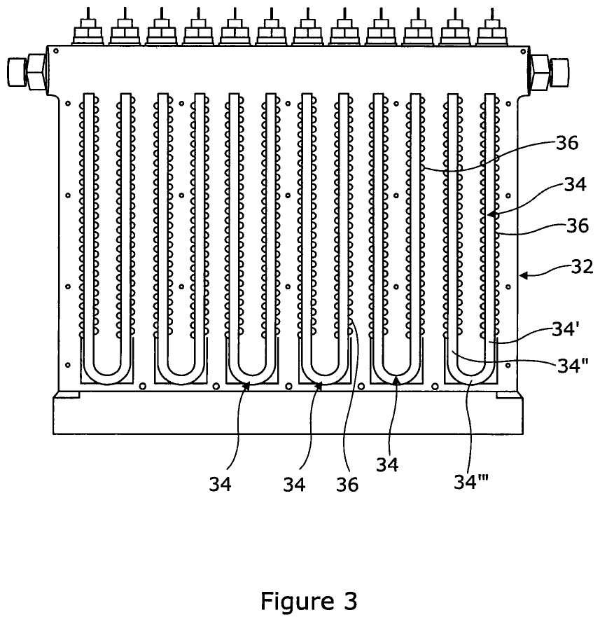

FIG. 3 is a front view of the electric heating elements used in the heater in one embodiment with independent spiral water paths associated with each heating element;

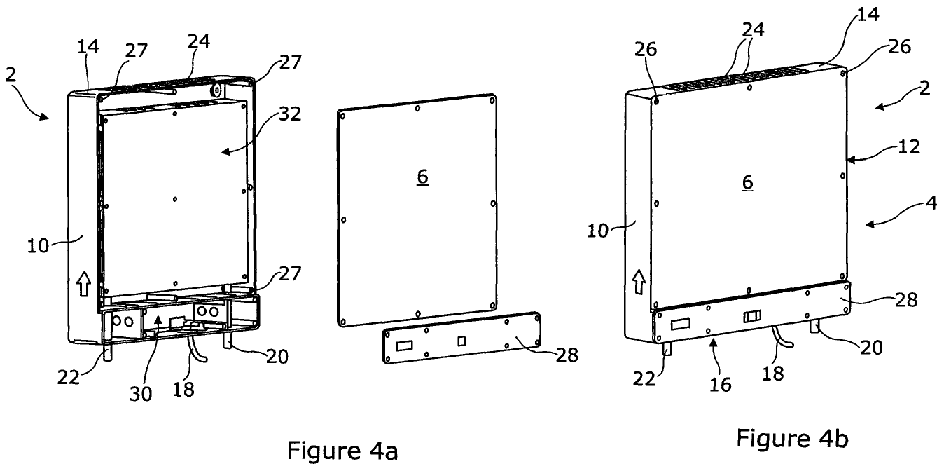

FIGS. 4a and 4b show a partially exploded view and a front perspective view of an electric heating system respectively according to an embodiment of the present invention;

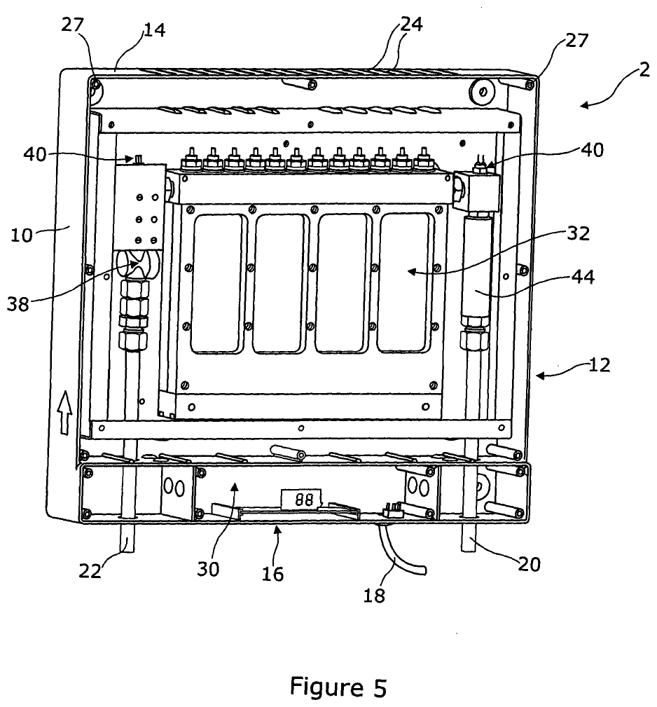

FIG. 5 shows the electric heating system in FIGS. 4a-4b with all the front covers removed;

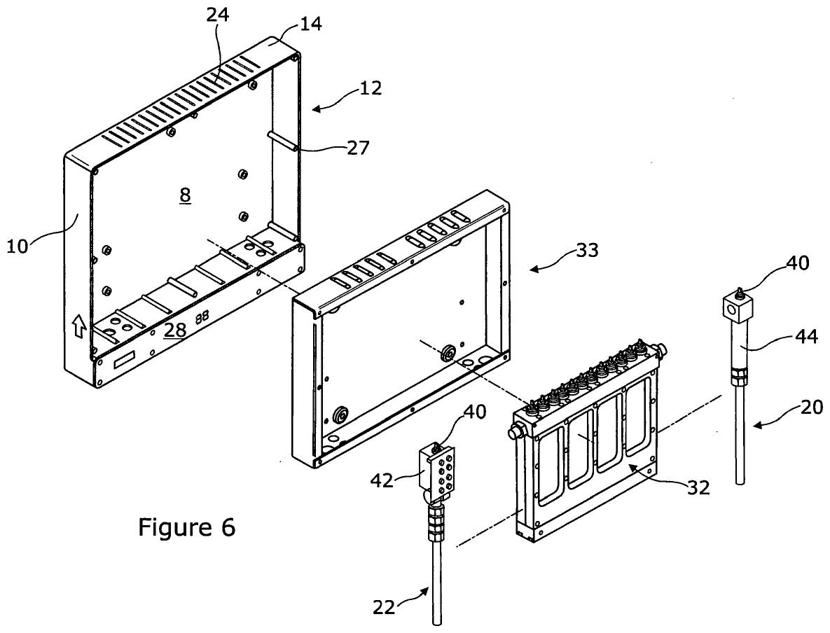

FIG. 6 is an exploded view of an electric heating system in one embodiment; and

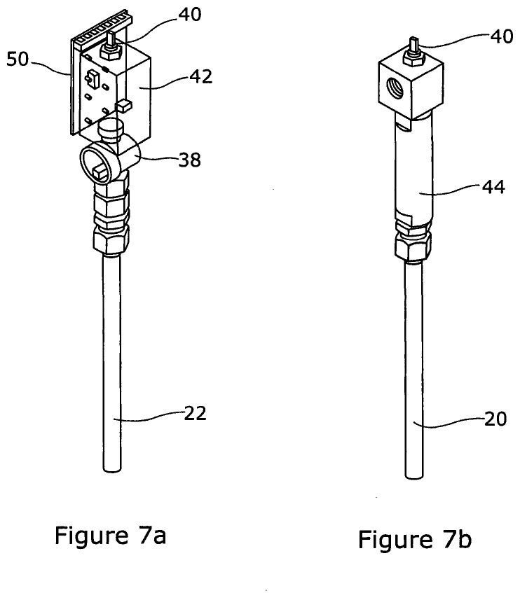

FIGS. 7a and 7b show a main water inlet feed assembly and a main water outlet feed assembly respectively for use in an electric heating system in one embodiment.

Referring to the figures, there is illustrated an electric fluid heating system in the form of an electric water heater or boiler 2.

The boiler 2 comprises an outer housing 4 having a main front panel 6, a rear panel 8, side walls 10, 12, a top wall 14 and a base wall 16. The boiler is powered by mains electricity delivered by an electrical cable 18. Water enters the boiler 2 through a main water inlet pipe 22 and water exits the boiler 2 through a mains water outlet pipe 20.

Ventilation slots 24 are provided along top wall 14 of the outer housing 4 to prevent the housing from becoming too hot in use, but it will be appreciated that ventilation slots could be provided on any or any combination of panels of the housing 4 as required.

The main front panel 6 is typically detachably attached to the housing 4 via a plurality of screws 26 which engage in corresponding apertures 27 provided on one or more panels of the remaining housing.

The rear panel 8 has attachment means in the form of screw apertures 25 associated therewith for allowing the panel to be mounted on a wall surface in use.

The front of the housing 4 further comprises main front panel 6 and a further front panel 28 is provided over a control unit 30 of the boiler 2.

A heating unit 32 is located in the housing 4 and comprises a plurality of heating elements 34, each of which is surrounded by a fluid or water path 36.

The heating unit 32 is typically located in a sub-housing assembly 33. The sub-housing assembly 33 is typically located in housing 4.

More particularly, in the illustrated example, the heating unit 32 comprises six separate heating elements 34. More or less heating elements could be provided depending on the required size of the boiler and/or the volume of water to be heated by the boiler in use. Each heating element 34 comprises two elongate and parallel heating element portions 34′, 34″, with a transverse heating element portion 34′ provided at a base thereof. The heating elements are electrically powered using electricity delivered to the housing 4 via electrical cable 18.

Each heating element 34 has a water path 36 independently associated with the heating element. Each water path 36 is arranged in a spiral around its corresponding heating element 34 so as to provide the greatest volume of water in close contact with the heating element 34 as possible. The water contained in water path 36 is typically in direct contact with the exterior surface of the heating element in use. As the water flows past the heating element along the spiral water path, heat is transferable from the heating element to the water, thereby heating the water.

The main water inlet pipe 20 includes a flow meter 38 for measuring the flow of water into the boiler 2 via inlet pipe 22. The water typically comes from a mains cold water supply in use. A temperature sensor in the form of a thermistor 40 is provided on the main water inlet pipe so that the temperature of the inflowing water can be measured. A heat sink block 42 is associated with the mains water inlet pipe 22 for cooling electronic circuitry associated with the control means of the system.

The main water outlet pipe 20 also has a temperature sensor in the form of a thermistor 40. An anti-scald valve 44 is provided on the main water outlet pipe to allow cold water to be mixed with the water leaving the boiler 2, if necessary, so as not to scald a user in use.

The control unit includes electronic processing means for processing data relating to the boiler 2. Communication means in the form of a transmitter and receiver (not shown) are provided in the control unit for data and one or more signals to be transmitted from and/or received by the unit.

Memory means can be associated with the control unit 30 for storing data relating to the boiler 2. This data can be used to optimise the performance of the boiler in use.

Each heating element 34 has a relay switch 50 associated with the same. Each relay switch 50 allows each heating element to be moved between an “on” condition and an “off” condition independently of the other heating elements. The control unit 30 controls operation of the relay switches 50.

The control unit 30 can be set to control the relay switches in any required order, such as all of them simultaneously or two or more of them in sequence.

If each or two or more of the heating elements are moved between “on” and “off” conditions in quick succession, the overall amount of electrical energy consumed by the heating elements in heating the surrounding water is reduced. Even when the heating element is in the off condition, heat is still typically transferred to the water surrounding the heating element.

The user is able to set the temperature of the water exiting the boiler 2 using the control unit. The heating elements are heated to the temperature required to heat the water to the user selected temperature. As such, as the heated water exits the boiler 2, it is at the required user selected temperature and the user is not required to mix the heated water with cold water to obtain the required temperature.

The control unit 30 can control any or any combination of parameters associated with the volume and/or speed of the water flow through the water path, the temperature of the heating elements, the time period of heating of the heating elements, the sequence of heating of the heating elements and/or the like to allow the required water temperature for the boiler to be obtained.

In one example, a number of pre-stored algorithms are provided with software in the control unit to allow a particular sequence of heating of the heating elements, switching of the heating elements, water flow and/or the like to be determined.

The volume of water flowing through the system is typically constant regardless of temperature. The system of the present invention is designed such that control unit can detect the demand of hot water required, the temperature at which the water is required, and determine how many heating elements need to receive power in order to heat the required volume of water, and what valves associated with what water flow paths need to be opened or closed in order to allow the water to flow in the required path past the required heating elements.

The term “hot” water is typically any water required above or significantly above the temperature of the incoming cold water feed which requires heat to be input to the same in order to reach the required temperature.

In one example, a system requiring hot water to be provided at 44° C., will deliver water at that temperature to a tap in a house at a flow of 5-7 litres per second. In contrast, a conventional gas combination boiler will take 1 minute and 56 seconds to deliver the same temperature of water to a particular tap in a house.

What is claimed is:

1. An electric fluid heating system, said system including first and at least second electrically powered heating elements, a fluid path associated with each of the first and at least second heating elements and arranged such that heat can be transferred from the heating element to fluid containable within the associated fluid path when said heating element is in at least an operable condition in use, and wherein the first and at least second heating elements are independently operable and/or controllable.

2. canceled

3. The system according to claim 1 wherein each fluid path is provided adjacent to, is in direct or substantially direct contact with and/or is in abutting relationship with its associated heating element(s); wherein the system includes a unit body and one or more, or each, fluid path is a channel defined around at least part of each heating element; and/or wherein each fluid path follows a curved, substantially curved, spiral, substantially spiral, helix and/or substantially helix path around the heating element with which it is associated.

4. canceled

5. canceled

6. The system according to claim 1 wherein each or one or more of the fluid paths has valve means or apparatus associated with the same to allow the flow and/or volume of fluid contained and/or flowing through the same to be independently controllable.

7. canceled

8. canceled

9. canceled

10. The system according to claim 1 wherein the system has a main fluid inlet means for allowing fluid to enter the system and a main fluid outlet means for allowing fluid to exit the system in use, wherein fluid conduit means are provided between the main fluid inlet means and the main fluid outlet means and each fluid path communicates with the conduit means via their own fluid inlet means and fluid outlet means.

11. canceled

12. The system according to claim 1 wherein each or one or more fluid paths are capable of communication or are arranged to selectively communicate with an adjacent fluid path within the system in use.

13. The system according to claim 1 wherein each or one or more fluid flow paths, valve means associated with each or said fluid flow paths and/or the heating elements are uniquely identified by identification means so that control means of the system can identify, operate and/or communicate with each or groups of them independently of the others.

14. The system according to claim 1 wherein each or two or more heating elements within the system are arranged to be heated and/or powered in sequence and/or in a pulsed condition, such that one or more heating elements are arranged or controlled to be in an “on” or relatively “high” power consuming condition when one or more of the other heating elements of the system are arranged or controlled to be in an “off” or relatively “low” power consuming condition.

15. canceled

16. canceled

17. canceled

18. The system according to claim 1 wherein a control means or apparatus is provided for controlling one or more parameters, characteristics and/or functions of the system, the heating elements, the valve means and/or the fluid paths in use; the control means are independently in communication with each fluid path and/or heating element; the control means are used to control one or more other electrical and/or electronic devices separate to and/or independent of the electric fluid heating system; and/or a single control means controls all the heating elements of the system simultaneously or substantially simultaneously.

19. The system according to claim 18 wherein the control means includes switching means and/or relay means for switching the electrical supply to one or more or all of the heating elements and/or for pulsing the heating elements between “on” or relatively “high” power consuming conditions and “off” or relatively “low” power consuming conditions.

20. The system according to claim 14 wherein the heating elements are arranged to be pulsed, switched and/or sequenced according to a pre-determined mathematical algorithm.

21. canceled

22. canceled

23. The system according to claim 1 wherein the system includes any or any combination of sensing means or one or more sensors provided on or associated with the system for sensing one or more conditions of the system, one of more components of the system and/or one or more conditions in the surrounding area or locality in which the system is located; ventilation and/or cooling apparatus; heat sink means; anti-scald means; water or fluid proof or tight compartment and/or housing; electronic processing unit; communication means for allowing the system to communicate with one or more external systems or communication systems, a computer system, a server, the Internet, or electronic processing means; memory and/or data storage means; a user interface; user actuation means.

24. The system according to claim 18 wherein the one or more parameters, functions and/or characteristics includes any or any combination of volume of fluid being heated at a particular time, the temperature of the fluid being heated, the time of day at which the fluid is heated, a plurality of times of day at which the fluid is to be heated, the length of time for which the fluid is heated for, which heating elements are being used to supply the heat to heat the fluid at any particular time, which fluid paths are to be used to allow flow of fluid through the system at any particular time, the wattage of electrical power used by the system and/or one or more heating elements, the monetary value of the electrical energy being consumed by the system, the amount of carbon being used by the system, or the carbon footprint of the system.

25. canceled

26. canceled

27. canceled

28. canceled

29. canceled

30. The system according to claim 1 wherein fluid only flows through the system when a fluid tap or fluid outlet associated or joined with the system is moved to an “on” condition from an “off” condition.

31. The system according to claim 1 wherein the system includes one or more fluid outlets or taps remote from a housing of the system to which fluid heated by the system is able to flow to in use, and each or one or more of said fluid outlets or taps has control means provided on or associated therewith and which are arranged to communicate with control means provided in or associated with the system housing.

32. A method of using an electric fluid heating system, said system including first and at least second electrically powered heating elements, a fluid path associated with each of the first and at least second heating elements, said method including the steps of moving at least one of the heating elements to an operable condition, heating fluid contained in a fluid path surrounding said heating element, and independently controlling and/or operating the first and at least second heating elements.
